(19) United States
(12) Patent Application Publication
(10) Pub. No.: US 2003/0080732 A1
(43) Pub. Date: May 1, 2003

(54) Angle sensor

(76) Inventors: Hiroyuki Okazaki, Sagamihara (JP); Yasuhiro Hiramatsu, Kawasaki (JP)

Correspondence Address: JoAnn Dilloway, Barley, Snyder, 126 East King Street, Lancaster, PA, 17602-2893, US

(21) Appl. No.: 10/278,370

(22) Filed: Oct. 23, 2002

(30) Foreign Application Priority Data
Oct. 31, 2001 (JP) 2001-333818

(51) Int. Cl. G01B 7/30

(52) U.S. Cl. 324/207.2; 324/207.25

(57) ABSTRACT

Angle sensor including a permanent magnet and a Hall effect element and which provides accurate detection of a rotational angle of an object on which it is mounted. The magnet is mounted on a rotor at a distance below the rotational center of the rotor when the rotor is in its reference position and such that the rotational center is situated on an axis that connects the poles of the magnet. An electronics package including the Hall element is fixed to a portion of the housing of the sensor such that the Hall element is at a distance from the rotational center and is positioned on the axis of the permanent magnet. The electronic package is oriented so that the magnetic flux detection direction of the Hall element is perpendicular to the axis of the permanent magnet. By slightly shifting the position of the Hall element from the rotational center of the rotor, the angle sensor provides highly accurate detection of the rotational angle of the object on which it is mounted.

### FIELD OF THE INVENTION

The present invention relates to an angle sensor including a permanent magnet and a Hall Effect element.

### BACKGROUND OF THE INVENTION

An angle sensor including a permanent magnet and a Hall Effect element (a type of magnetic converting element, hereinafter referred to as “Hall element”) is described in Japanese Unexamined Patent Publication No. 10 (1998)-132506. The sensor described in this patent publication detects the throttle position of an internal combustion engine of an automobile and comprises a rotor portion formed as a rotational shaft, a permanent magnet having a semicircular cross section and arranged coaxially with the rotational shaft, a non-rotating supporting body, and a Hall element arranged on the supporting body and positioned on the central axis of the rotational shaft. When the permanent magnet rotates relative to the Hall element, the magnetic field direction with respect to the magneto-sensitive surface of the Hall element changes, and an electrical signal corresponding to the angle of the change of the magnetic field direction is output from the Hall element. The output electrical signal corresponds to the angular change of the permanent magnet, i.e., the throttle position.

Another throttle position sensor for detecting the throttle position of an internal combustion engine is described in Japanese Unexamined Patent Publication No. 5 (1993)-26610. The sensor described in this patent publication comprises a pair of permanent magnets arranged on an arc formed with a rotational shaft as its center and a Hall element for detecting the throttle position arranged at the center between the two permanent magnets. The Hall element is supported by a fixed member. Another permanent magnet is arranged at a collar portion of the rotating shaft and another Hall element for detecting idling of the engine is arranged in the vicinity of this additional permanent magnet at a position corresponding to the position of the fixed member. The idle-detecting Hall element is positioned on the boundary line between the pair of permanent magnets during an idle state of the engine.

In the above-described sensors for detecting throttle position, when the permanent magnets rotate in proportion to the throttle position, the Hall elements convert a change in magnetic field to an output electrical signal corresponding to the throttle position, and an engine is electronically controlled based on the electrical signal. In the above-described arrangements of the Hall elements and the permanent magnets, the Hall elements are positioned at the rotational center of the permanent magnets. In this manner, the detection accuracy is within a tolerance of 2%. However, further improvements in detection accuracy are desired, and the above-described angle sensors are limited in their ability to meet this demand because within a certain angular range, the sensor angle and the output voltage of the Hall element becomes a sine curve, and not a linear function. Therefore, the correlation between the true value and the output value, the so-called linearity, becomes inadequate. More specifically, within a range of about ±45° from a reference position of the permanent magnet, the correlation is comparatively linear, but when converted to linearity, deviations, i.e., errors, on the order of about ±100 mV occur. This error corresponds to approximately 2% of the output of the Hall element.

### SUMMARY OF THE INVENTION

It is an object of the present invention to provide an angle sensor which provides a highly accurate detection of a rotational angle.

In order to achieve this and other objects, a first angle sensor in accordance with the present invention comprises a rotor having a rotational center, a permanent magnet mounted on the rotor for detecting a rotational angle of the object to which it is mounted, a housing portion and a Hall element mounted in connection with the housing portion for outputting an electrical signal corresponding to a magnetic flux density of the permanent magnet. The rotor is rotatable relative to the housing portion such that the permanent magnet arranged on the rotor is rotatable relative to the Hall element arranged in connection with the housing portion. The permanent magnet is arranged at a set or predetermined distance from the rotational center of the rotor and such that the rotational center of the rotor is situated on an axis of the permanent magnet, i.e., the axis of the permanent magnet faces toward the rotational center. Also, the Hall element is arranged on the axis of the permanent magnet on an opposite side of the rotational center than the side on which the permanent magnet is arranged and at an offset distance from the rotational center which is smaller than the distance between the permanent magnet and the rotational center of the rotor when the rotor is in its reference position. In this manner, the magnetic flux detection direction of the Hall element is perpendicular to the axis of the permanent magnet (when the rotor is in its reference position).

Further, the ratio of the distance between the permanent magnet and the rotational center of the rotor to the offset distance of the Hall element from the rotational center, as well as the rotational angle of the rotor, are set to be substantially equal to the range in which the output electrical signal linearly transforms, i.e., a range in which the output electrical signal fro the Hall element is a linear function of the rotational angle.

Another embodiment of an angle sensor in accordance with the present invention comprises a rotor having a rotational center, a permanent magnet mounted on the rotor for detecting a rotational angle of an object on which it is mounted, a housing portion, and a Hall element mounted in connection with the housing portion for outputting an electrical signal corresponding to a magnetic flux density of the permanent magnet. The rotor is rotatable relative to the housing portion such that the permanent magnet arranged in connection with the rotor is rotatable relative to the Hall element arranged on the housing portion. As in the first embodiment, the permanent magnet is arranged at a set or predetermined distance from the rotational center of the rotor and such that the rotational center of the rotor is situated on the axis of the permanent magnet, i.e., the axis of the permanent magnet faces toward the rotational center, and the Hall element is arranged on the axis of the permanent magnet on an opposite side of the rotational center from the side on which the permanent magnet is arranged. The Hall element is arranged at an offset distance from the rotational center which is smaller than the distance between the permanent magnet and the rotational center of the rotor when the rotor is in its reference position. In this manner, the magnetic flux detection direction of the Hall element is perpendicular to the axis of the permanent magnet (when the rotor is in its reference position).

In this embodiment, the ratio of the distance between the permanent magnet and the rotational center of the rotor to the offset distance of the Hall element from the rotational center, as well as the rotational angle of the rotor, are set so that the output electrical signal is within a predetermined margin of error.

As used herein, the phrase “axis of the permanent magnet” refers to an imaginary line that passes through the N and S poles and the center of the magnet.

In a preferred embodiment, the ratio of the distance between the permanent magnet and the rotational center of the rotor to the offset distance of the Hall element from the rotational center is within the range of about 10:0.5 to about 10:3.5.

Further, in another preferred embodiment, the rotational angle of the rotor is within the range of about +90° to about −90° and the ratio of the distance between the permanent magnet and the rotational center of the body to the offset distance of the Hall element from the rotational center is within the range of about 10:1.5 to about 10:2.5.

In another embodiment, the rotational angle of the rotor is within the range of about +45° to about −45°.

In some embodiments of the angle sensor in accordance with the present invention described above, the permanent magnet is arranged at a predetermined distance from the rotational center of a rotor so that the rotational center of the rotor is situated on the axis of the permanent magnet and the Hall element is arranged on the axis of the permanent magnet on the other side of the rotational center at an offset distance smaller than the distance between the permanent magnet and the rotational center when the rotor is in its reference position. The Hall element is arranged so that the magnetic flux detection direction thereof is perpendicular to the axis of the permanent magnet. The ratio of the distance between the permanent magnet and the rotational center to the offset distance of the Hall element from the rotational center, as well as the rotational angle of the rotor, are set to be substantially equal to the range in which the output electrical signal linearly transforms. In view of this construction, a significant advantage is obtained.

Specifically, by slightly shifting the position of the Hall element from the rotational center of the permanent magnet, an electrical signal generally having a high degree of linearity can be obtained from the Hall element within a desired angular range. Since the output from the Hall element is linear, correction thereof is easy, thereby enabling high detection accuracy for a rotational angle.

In other embodiments of the angle sensor in accordance with the present invention, the ratio of the distance between the permanent magnet and the rotational center to the offset distance of the Hall element from the rotational center, as well as the rotational angle of the rotor, are set so that the output electrical signal is within a predetermined margin of error. Therefore, even if the output electrical signal is not linear, because the amount of error is extremely small, it can be used as is, without correction, and a highly accurate angle detection can be obtained.

In embodiments wherein the ratio of the distance between the permanent magnet and the rotational center to the offset distance of the Hall element from the rotational center is within the range of 10:0.5 to 10:3.5, the linearity of the output signal is extremely favorable. Therefore, the accuracy of the detection of the rotational angle is improved in comparison with conventional angle sensors.

In addition, in embodiments wherein the rotational angle of the rotor is within the range of about +90° to about −90° and the ratio of the distance between the permanent magnet and the rotational center to the offset distance of the Hall element from the rotational center is within the range of 10:1.5 to 10:2.5, a high level of linearity is exhibited through the entire range of ±90°. The amount of error is small so that the accuracy of the detection of the rotational angle is extremely high. This may be applied to, for example, detecting the motion of an arm joint of an industrial robot which has a wide range of motion.

In embodiments wherein the rotational angle of the rotor is within the range of about +45° to about −45°, a high level of linearity is exhibited within this range. Therefore, the accuracy of the detection of the rotational angle is extremely high. This may be applied for detecting the throttle position of an internal combustion engine, for which a rotational range of ±45° is sufficient.

### BRIEF DESCRIPTION OF THE DRAWINGS

The invention will now be described by way of example with reference to the accompanying figures of which:

FIG. 1 is an exploded perspective view of the angle sensor in accordance with the present invention.

FIG. 2 is a sectional view of the angle sensor taken along the line 2-2 in FIG. 1.

FIG. 3 is a sectional view of the angle sensor taken along the line 3-3 in FIG. 1.

FIG. 4 is a schematic view showing the positional relationship between the permanent magnet mounted on the rotor and the electronics package having the Hall element therein.

FIGS. 5A-5E show graphs of data of an angle sensor wherein the offset distance V between the Hall element and the rotational center of the rotor is 0; wherein FIG. 5A shows the relationship between the magnetic flux density and the rotational angle when the rotational angle of the permanent magnet is within the range of ±180°; FIG. 5B shows the relationship between the magnetic flux density and the approximate line when the rotational angle is within the range of ±90°; FIG. 5C shows the linearity for the chart shown in FIG. 5B; FIG. 5D shows the relationship between the magnetic flux density and the approximate line when the rotational angle is within the range of ±45°; and FIG. 5E shows the linearity for the chart shown in FIG. 5D.

FIGS. 6A-6E show graphs for an embodiment of an angle sensor in accordance with the present invention wherein the ratio of the offset distance V to the rotating radius r of the permanent magnet is 0.5:10; wherein the data of FIGS. 6A, 6B, 6C, 6D, and 6E correspond to the data of FIGS. 5A, 5B, 5C, 5D, and 5E, respectively.

FIGS. 7A-7E show graphs for an embodiment of an angle sensor in accordance with the present invention wherein the ratio of the offset distance V to the rotating radius r of the permanent magnet is 1:10; wherein the data of FIGS. 7A, 7B, 7C, 7D, and 7E correspond to the data of FIGS. 5A, 5B, 5C, 5D, and 5E, respectively.

FIGS. 8A-8E show graphs for an embodiment of an angle sensor in accordance with the present invention wherein the ratio of the offset distance V to the rotating radius r of the permanent magnet is 1.5:10; wherein the data of FIGS. 8A, 8B, 8C, 8D, and 8E correspond to the data of FIGS. 5A, 5B, 5C, 5D, and SE, respectively.

FIGS. 9A-9E show graphs for an embodiment of an angle sensor in accordance with the present invention wherein the ratio of the offset distance V to the rotating radius r of the permanent magnet is 2:10; wherein the data of FIGS. 9A, 9B, 9C, 9D, and 9E correspond to the data of FIGS. 5A, 5B, 5C, 5D, and 5E, respectively.

FIGS. 10A-10E show graphs for an embodiment of an angle sensor in accordance with the present invention wherein the ratio of the offset distance V to the rotating radius r of the permanent magnet is 2.5:10; wherein the data of FIGS. 10A, 10B, 10C, 10D, and 10E correspond to the data of FIGS. 5A, 5B, 5C, 5D, and 5E, respectively.

FIGS. 11A-11E show graphs for an embodiment of an angle sensor in accordance with the present invention wherein the ratio of the offset distance V to the rotating radius r of the permanent magnet is 3:10; wherein the data of FIGS. 11A, 11B, 11C, 11D, and 11E correspond to the data of FIGS. 5A, 5B, 5C, 5D, and 5E, respectively.

FIGS. 12A-12E show graphs for an embodiment of an angle sensor in accordance with the present invention wherein the ratio of the offset distance V to the rotating radius r of the permanent magnet is 3.5:10; wherein the data of FIGS. 12A, 12B, 12C, 12D, and 12E correspond to the data of FIGS. 5A, 5B, 5C, 5D, and 5E, respectively.

### DETAILED DESCRIPTION OF THE PREFERRED EMBODIMENTS

Preferred embodiments of the angle sensor in accordance with the present invention (hereinafter simply referred to as the “sensor”) will be described with reference to the attached drawings.

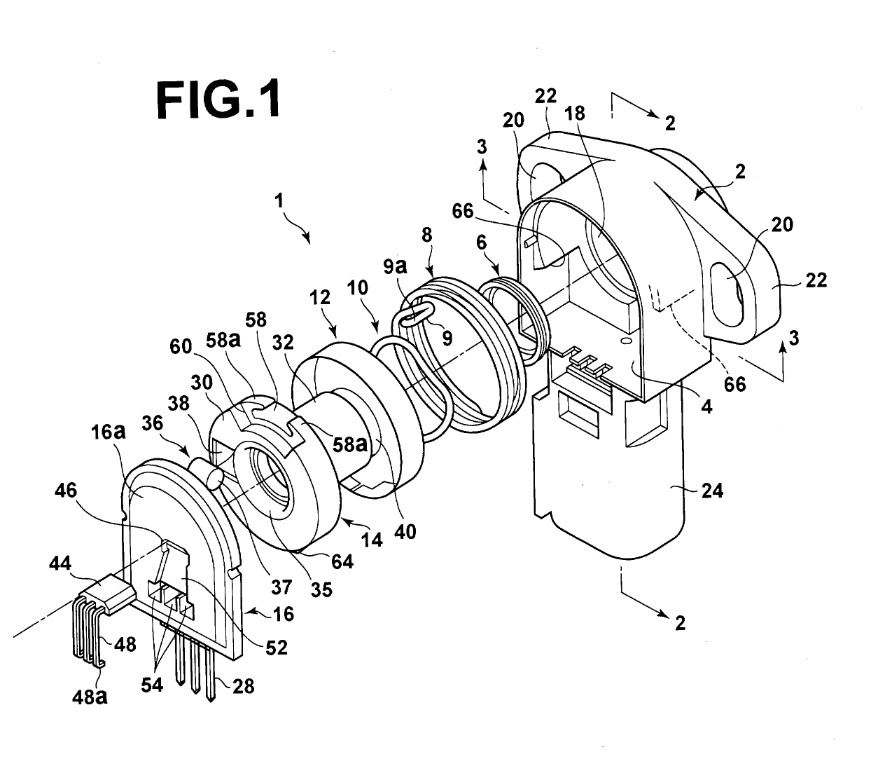

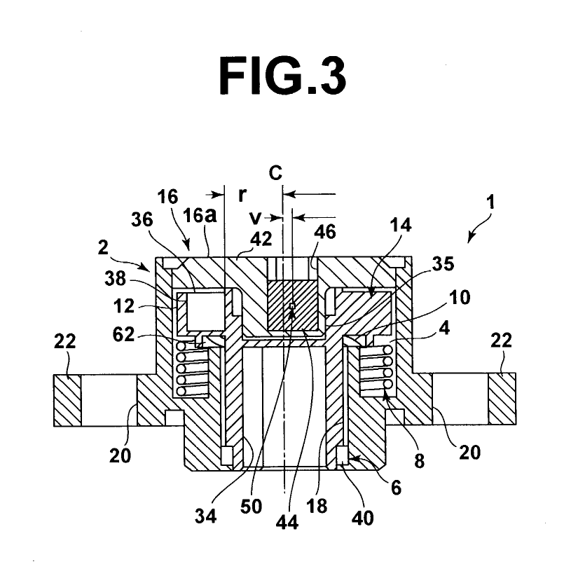

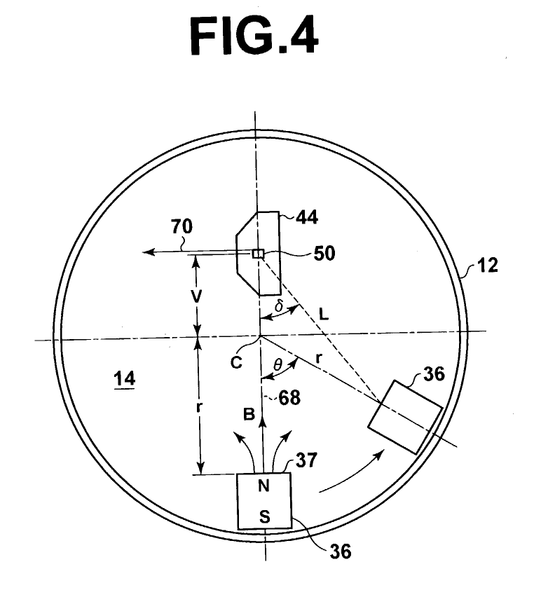

Referring first to FIGS. 1-3, the sensor 1 comprises a housing including an insulative part 2 having a space 4 which opens to the side thereof, the insulative part 2 constituting a first portion of the housing. A seal ring 6, a coil spring 8, a wave washer 10, an annular yoke 12 and a rotor (or other type of a rotating body) 14 are sequentially arranged within the space 4. The housing also includes a cover 16 which seals the space 4 after the above components have been mounted therein such that the cover 16 constitutes a second portion of the housing. An electronics package 44 containing a Hall element 50 (as seen in FIGS. 3 and 4) is mounted on the cover 16. Electronics package 44 generally includes an A/D converter, a digital signal processor (DSP), a D/A converter and an analog amplifier. This type of electronics package is commonly referred to as a Hall IC. Instead of the cover 16, another non-rotatable, or fixed, supporting body or portion of the housing may be used to support the electronics package 44.

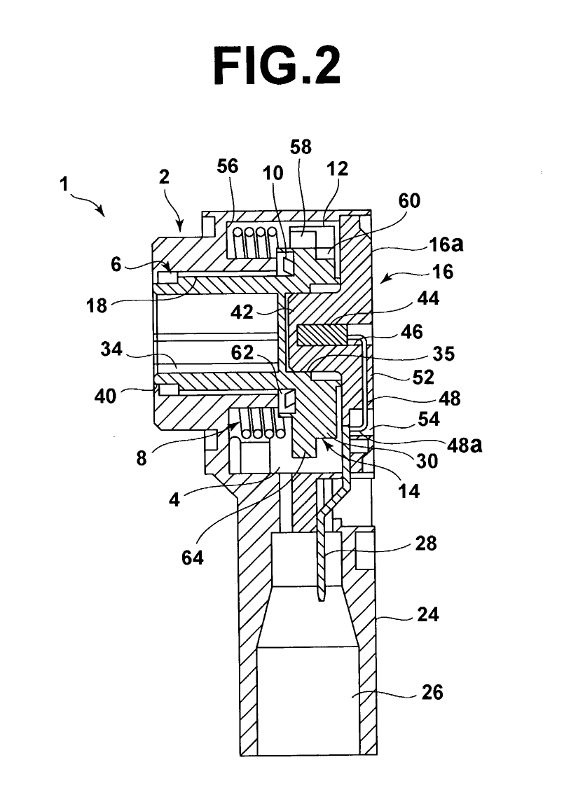

The upper portion of the space 4 is formed in an arcuate shape and has an aperture through which the rotor 14 is inserted. In addition, a pair of flanges 22, each having a mounting hole 20, is provided at the upper portion of the housing portion 2 to enable mounting of the sensor 1 at a predetermined position on an engine (not shown) or other object. A connector portion 24 is integrally formed at the lower portion of the housing portion 2 for electrically connecting the output of the sensor 1 to an electronic control apparatus (not shown). As most clearly seen in FIG. 2, an engagement recess 26 is formed at the connector portion 24 for engaging another connector (not shown). Three terminals 28 extending within the space 4 are aligned in the engagement recess 26 (see FIG. 2).

The rotor 14 may be formed from an insulative material such as a resin and comprises a discoid collar 30 and a cylindrical trunk portion 32 extending perpendicularly with respect to the collar 30 from the center thereof. The collar 30 and the trunk portion 32 have mounting holes 34,35, respectively, formed through the interiors thereof. A shaft (not shown) linked to a throttle valve (not shown) of the engine is inserted through the mounting hole 34 and fixed therein. A housing recess 38 is formed in the vicinity of the outer peripheral edge portion of the collar 30 and is arranged to house a cylindrical permanent magnet 36. An annular step portion 40 is formed in the vicinity of the tip of the trunk portion 32 and arranged to receive the seal ring 6 thereon. In addition, a cutout 58 is formed at a portion of the outer periphery of the collar 30. Protrusions 58a project inward from both edges of the cutout 58. A curved recess 60 is formed on the outer surface of the collar 30 adjacent to the cutout 58.

A hook 9 is formed on the end of the coil spring 8 and is hooked on the protrusion 58a to bias the rotor 14 in a predetermined direction, i.e., in the direction that closes the throttle valve. The curved recess 60 houses a tip 9a of the hook 9 in order to prevent the tip 9a from interfering with the other components. A protrusion 64 is integrally formed at the lower edge of the collar 30 and defines the rotational range of the rotor 14. More specifically, the protrusion 64 engages a pair of downwardly facing stop surfaces 66 formed within the space 4 of the housing portion 2 to define the rotational range of the rotor. When the rotor 14 is in its reference position, the protrusion 64 is positioned at the bottom thereof, and the rotor 14 is rotatable within a predetermined range until the protrusion 64 engages one of the stop surfaces 66.

The cover 16 is a plate having an arcuate upper edge, shaped to match the opening of the space 4. A cylindrical protrusion 42 is formed on the interior side of the cover 16, at the approximate center thereof, and is adapted to be inserted into the mounting hole 35 of the rotor 14 (see FIGS. 2 and 3). The electronics package 44 is inserted into an insertion opening 46 formed in the protrusion 42. The electronics package 44 is substantially rectangular but has both edges of an upper surface beveled. The electronics package 44 is inserted into the insertion opening 46, which is substantially rectangular in cross section, and then fixed therein. As most clearly seen in FIGS. 3 and 4, the electronics package is biased away from the rotational center C of the rotor 14, i.e., it is placed at a distance from the rotational center C. Accordingly, the Hall element 50 situated at the center of the electronics package 44 in its axial direction is also biased away from the rotational center C, i.e., at a distance from the rotational center C. The function of this construction will be described later.

The three contacts 48 linked to the Hall element extend downward from the electronics package 44. A groove 52 is formed on the outer surface 16a of the cover 16 extending in a downward direction and communicates with the insertion opening 46. Three cavities 54 are formed from the lower edge of the groove 52, each arranged to receive a respective one of the terminals 28. The contacts 48 are arranged in the groove 52, while tips 48a of the contacts 48 bend toward the terminals 28 and are arranged in the cavities 54. The contacts 48 and the terminals 28 are soldered together, and electrical connections are established therebetween.

When the rotor 14 is positioned within the space 4, the space between the rotor 14 and the aperture 18 of the housing portion 2 is sealed by the seal ring 6, thereby preventing the entry of water, oil, and the like into the housing portion 2 (see FIGS. 2 and 3). The coil spring 8 is positioned within an annular groove 56 of the housing portion 2. The wave washer 10 is positioned within an annular groove 62 formed in the collar 30 of the rotor 14 between the housing portion 2 and the rotor 14. In this manner, the washer 10 continuously urges the rotor 14 towards the cover 16 and maintains the positional relationship between the Hall element of the electronics package 44 and the permanent magnet 36 held by the rotor 14. More specifically, the center of the permanent magnet 36 and the Hall element 50 are positioned to be coplanar, as seen in FIG. 3. The permanent magnet 36 and Hall element 50 may be slightly shifted from the coplanar relationship, but, the detection sensitivity is optimal when they are coplanar. The yoke 12 is metallic and is arranged on the outside of the rotor 14 to provide a two dimensionally-sealed magnetic circuit thereby eliminating the influence of exterior magnetism on the Hall element.

Referring now to FIG. 4, FIG. 4 is a schematic view showing the positional relationship between the permanent magnet 36 mounted on the rotor 14 and the electronics package 44 having the Hall element 50 therein, when the rotor 14 is in its reference position. The permanent magnet 36 is mounted on the rotor 14 so that it is positioned directly under the rotational center C of the rotor 14 (when the rotor 14 is in the reference position), with a distance r between a terminal face 37 of the permanent magnet 36 and the rotational center C, and so that an axis 68 that connects the N pole and the S pole of the magnet 36 faces the rotational center C. In other words, the rotational center C is situated on the axis 68 of the permanent magnet 36. The electronics package 44 is fixed to the cover 16 so that the Hall element 50 is separated or offset from the rotational center C by a distance V, while the Hall element 50 is positioned along the axis 68. The electronics package 44 is positioned such that the magnetic flux detection direction 70 of the Hall element 50 is perpendicular to the axis 68 (when the rotor 14 is in its reference position).

When the rotor 14 rotates 0 degrees counterclockwise, the following equations are established. The output of the Hall element ∞ B sin δ; and the output of the Hall element ∞ 1/L².

Accordingly, the output of the Hall element

∞ B sin δ/L²=Br/L sin θ/L²=Br/L³ sin θ

wherein:

L is the distance between the permanent magnet 36 and the Hall element 50;

δ is the angle formed by the permanent magnet 36 and the axis 68; and

B is the magnetic flux density of the permanent magnet 36. A sine curve output which is substantially proportional to the magnetic flux density B is obtained from the Hall element 50 by means of the foregoing equations.

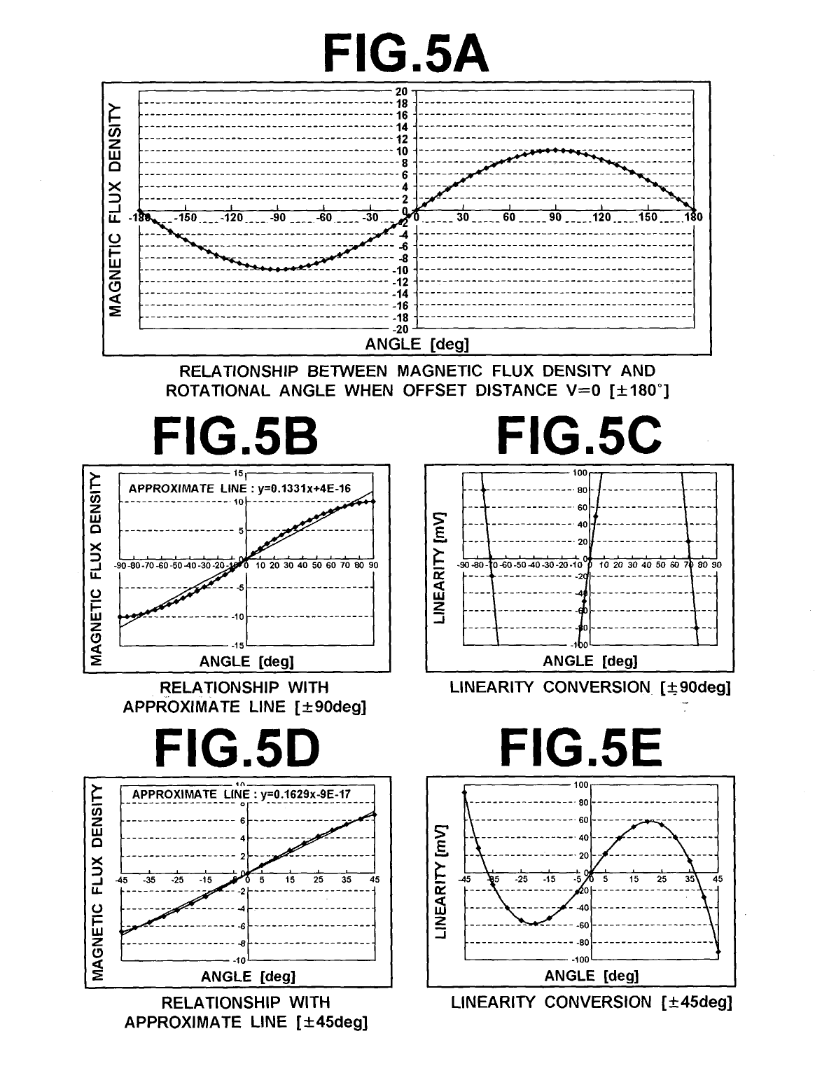

The results derived by the foregoing equations for the change in magnetic flux density as well as the linearity (shift from approximate lines) as the offset distance V of the Hall element is changed, are shown in FIGS. 5A-12E for several offset distances between the Hall element 50 and the rotational center C. The offset distances V will be referred to as 0.5, 1, 1.5, 2, 2.5. In addition, when the permanent magnet 36 rotates in the counterclockwise direction, the values in the graph become positive (+), and when the permanent magnet 36 rotates in a clockwise direction, the values in the graph become negative (−).

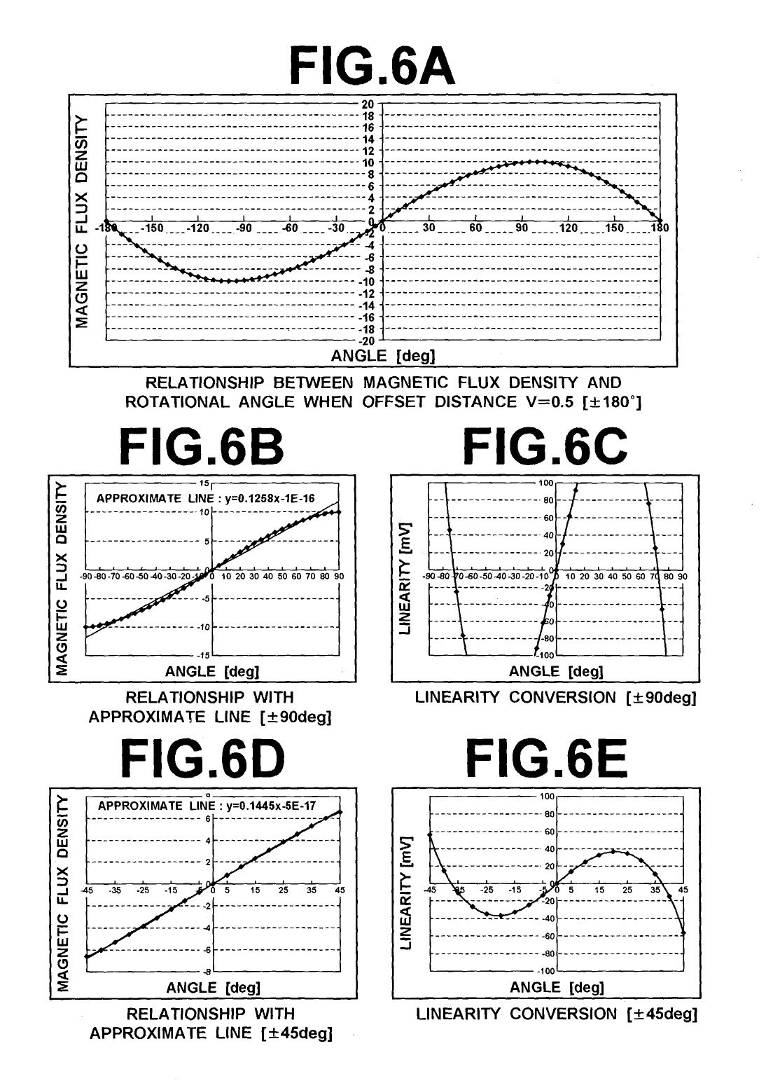

FIGS. 5A, 6A, 7A, 8A, 9A, 10A, 11A, and 12A indicate the change in the magnetic flux density detected by the Hail element 50 as the permanent magnet 36 moves through a range of ±180°, and are graphs approximating a sine curve. The most linear changes occur when the rotational angle θ is in the vicinity of 0°, i.e., in the vicinity of the reference position of the rotor 14. As the rotational angle θ increases, the magnetic flux density B increases, until the magnetic flux density B passes its peak. Beyond this point, even if the rotational angle θ increases, the graph changes in a curvilinear manner and the magnetic flux density decreases. The sensor is accurate for use in a wide range of applications the closer that the curve which contains 0° is to a straight line and the larger the rotational angle θ is while the linear state is maintained (i.e., the linear relationship between the magnetic flux density and the angle). In FIG. 5A, which can be considered comparable to the situation in a conventional sensor when the Hall element is situated at the rotational center of the rotor (i.e., the offset distance V is 0), at portions other than in the vicinity of 0°, the output is a gradual curve that deviates from a linear change. With regard to the situations in which the offset distances V are 0.5, 1, 1.5, 2, 2.5, 3, and 3.5, shown in FIGS. 6A, 7A, 8A, 9A, 10A, 11A, and 12A, respectively, it is seen that favorable linear changes occur. By setting lines closest to these curves as approximate lines, and by determining to what degree the curves deviate from the approximate lines, the offset distance V appropriate for the sensor 1, as well as the rotational angle θ, can be determined.

An opening/closing mechanism of a throttle valve to which the present embodiment is applied is generally used within the range of ±45°. Other applications, for example, a robot joint or the like, are used within the range of ±90°. If the changes in magnetic flux density are observed within these ranges, the following results are obtained.

Initially, the conventional situations in which the offset distance V is 0 will be described with reference to FIG. 5B and FIG. 5D. FIGS. 5B and 5D show the degree of deviation, i.e., error, of the (partial) sine curve representing the magnetic flux density B from a line (approximate line) that approximates the curve. The lines indicated in FIGS. 5B and 5D are approximate lines within the angular ranges shown in the figures, so they are not necessarily the same line. Within the range of ±90° shown in FIG. 5B, the error is comparatively large, and within the range of ±45° shown in FIG. 5D, the error is comparatively small. The linearity graphs of FIGS. 5C and 5E, corresponding to FIGS. 5B and 5D respectively, express these errors as numerical values. These graphs show the degree to which the error in the magnetic flux density is expressed as output error, and it is seen that in the range of ±90°, the output error is very large. This indicates that the error of the electrical signal output by the Hall element 50, corresponding to the amount of magnetic flux density B, is extremely large, and difficult to correct. Accordingly, such a sensor cannot be used as an accurate sensor within the range of ±90°. In addition, within the range of ±45°, maximum errors of approximately ±90 mV are observed when the rotational angle is ±45°. A deviation of ±90 mV corresponds to ±1.8% of the output of a Hall element 50, when it is considered that the output of the Hall element 50 is generally on the order of 5 V. Accordingly, when the offset distance is 0, and the sensor is used in the range of ±45°, the sensor has a maximum error of ±1.8%.

An embodiment of the present invention in which the offset distance V is 0.5 (and the ratio of the offset distance to the distance between the permanent magnet 36 and the rotational center C is 0.5:10) will now be described with reference to FIGS. 6A-6E. In the range of from +90° to −90°, the degree of deviation from the approximate line is very large as shown in FIG. 6C. Therefore, the sensor cannot be used for all applications, similar to the sensor without any offset distance between the Hall element 50 and the rotational center C (discussed above with reference to FIGS. 5A-5E). In the range of ±45°, maximum errors of ±60 mV are observed when the rotational angle is ±45° (see FIGS. 6E). A deviation of ±60 mV corresponds to ±1.2% of the output of a Hall element 50, when it is considered that the output of the Hall element 50 is generally on the order of 5 V. Accordingly, it can be seen that in the range of ±45°, less error occurs than in the sensor described above with reference to FIGS. 5A-5E, and detection of the rotational angle is performed with higher accuracy. Accordingly, when the offset distance V is 0.5, the sensor can be used as an acceptable angle sensor in the range of ±45°.

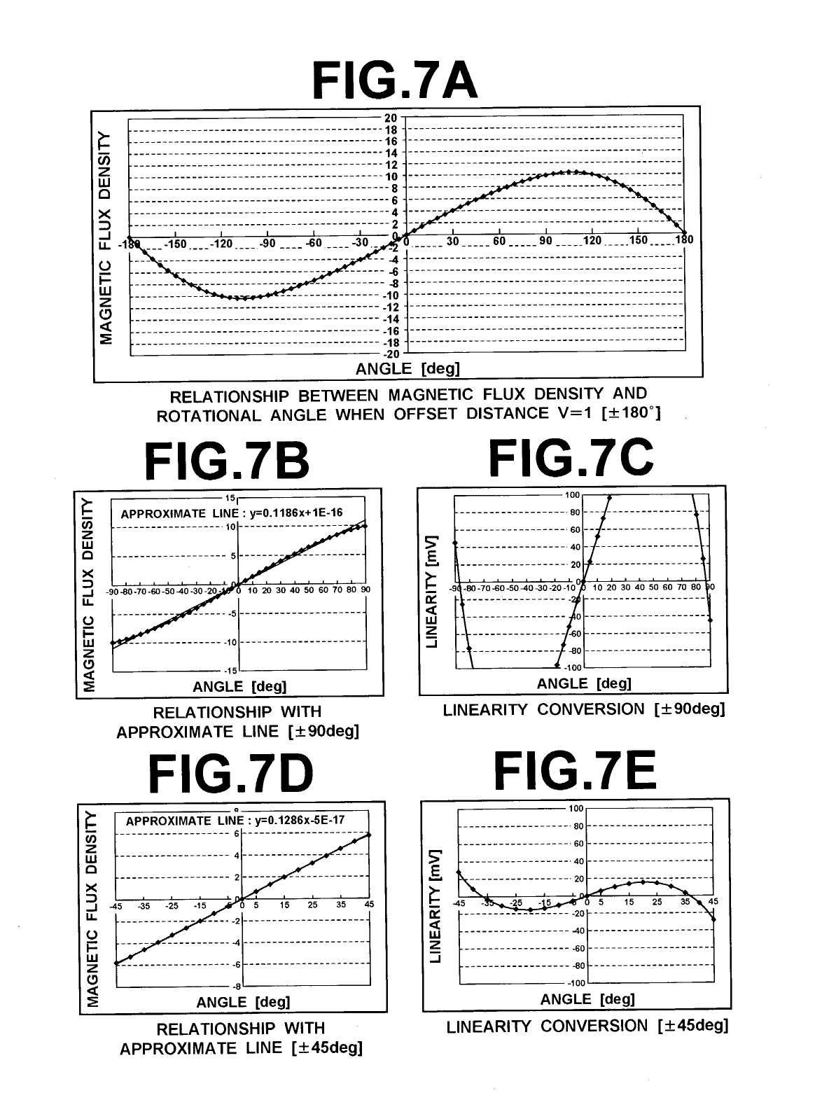

Next, an embodiment of the present invention in which the offset distance V is 1 (and the ratio of the offset distance to the distance between the permanent magnet 36 and the rotational center C is 1:10) will be described with reference to FIGS. 7A-7E. In the range of ±90°, the degree of deviation is very large (see FIG. 7C). Therefore, the sensor cannot be used for all applications, similar to a conventional sensor without any offset distance between the Hall element 50 and the rotational center C. In the range of ±45°, errors of approximately ±30 mV are observed when the rotational angle is ±45° (see FIG. 7E). A deviation of ±30 mV corresponds to ±0.6% of the output of a Hall element 50, when it is considered that the output of the Hall element 50 is generally on the order of 5 V. In addition, excluding the vicinity of ±45°, the graph exhibits favorable linearity with errors less than ±20 mV over substantially the entire range. This favorable linearity facilitates output correction by which the error can be made even smaller. Accordingly, in the range of ±45°, the sensor 1 is capable of detection of a higher accuracy than the conventional sensor described above with reference to FIGS. 5A-5E, as well as the embodiment of the present invention in which the offset distance V is 0.5, described above with reference to FIGS. 6A-6E. Accordingly, when the offset distance V is 1, the sensor can be used as an acceptable sensor in the range of ±45°.

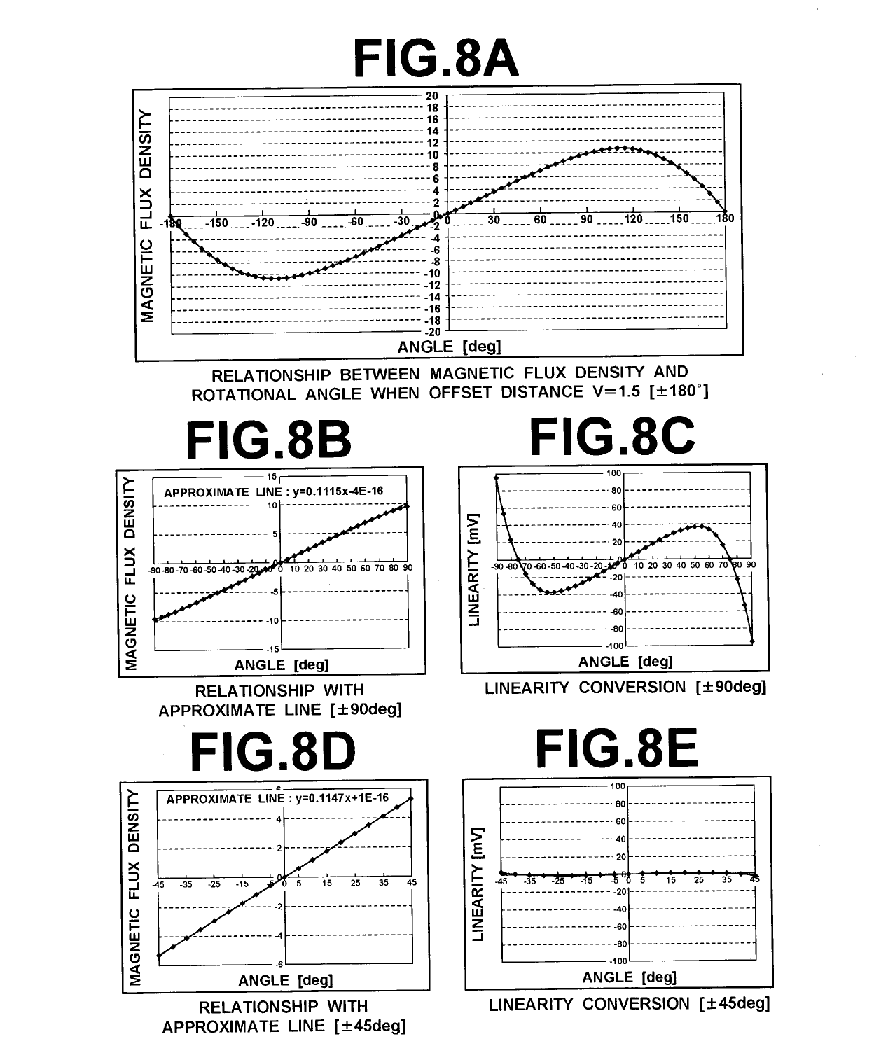

An embodiment of the present invention in which the offset distance V is 1.5 (and the ratio of the offset distance to the distance between the permanent magnet 36 and the rotational center C is 1.5:10) will now be described with reference to FIGS. 8A-8E. In the range of ±90°, deviations of approximately ±90 mV are observed at ±45° (see FIG. 8C). This deviation translates to errors of approximately 1.8%. However, this value indicates a significant improvement over the angle sensors described above with reference to FIGS. 5A-7E in which the offset distance V is 0, 0.5 and 1. Although it is still somewhat large as a numerical value, the improvement in detection accuracy with regard to the range of ±90° is significant. In the range of ±45°, the curve approximately overlaps the line as shown in FIG. 8D, and this means that there is almost no error (see FIG. 8E). It also indicates that the output of the Hall element 50 can be used as is, without correction. Accordingly, in the embodiment wherein the offset distance V is 1.5, the sensor can be used as a highly accurate sensor in the range of ±90° as well as in the range of ±45°. The sensor is particularly accurate in the range of ±45°.

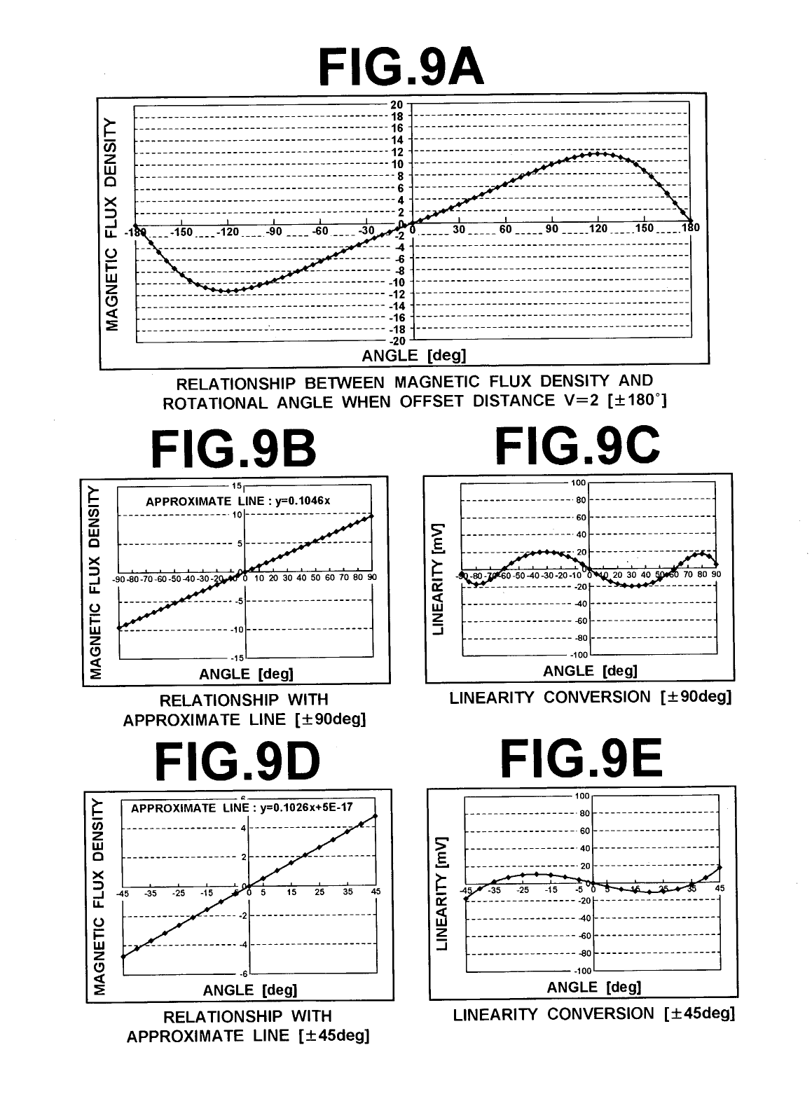

An embodiment of the present invention in which the offset distance V is 2 (and the ratio of the offset distance to the distance between the permanent magnet 36 and the rotational center C is 2:10) will now be described with reference to FIGS. 9A-9E. In the range of ±90°, the curve approximately overlaps the approximate line, and the degrees of deviation are within the range of ±20 mV (see FIGS. 9B and 9C). This deviation translates to errors of approximately 0.4%, which is an extremely small amount of error. In the range of ±45° as well, the curve almost overlaps the line, and the degrees of deviation are within the range of ±10 mV (see FIGS. 9D and 9E). This deviation translates to errors of approximately 0.2% and again is extremely small. Accordingly, in the embodiment wherein the offset distance V is 2, the sensor can be used as a highly accurate sensor in the range of ±90° as well as in the range of ±45°.

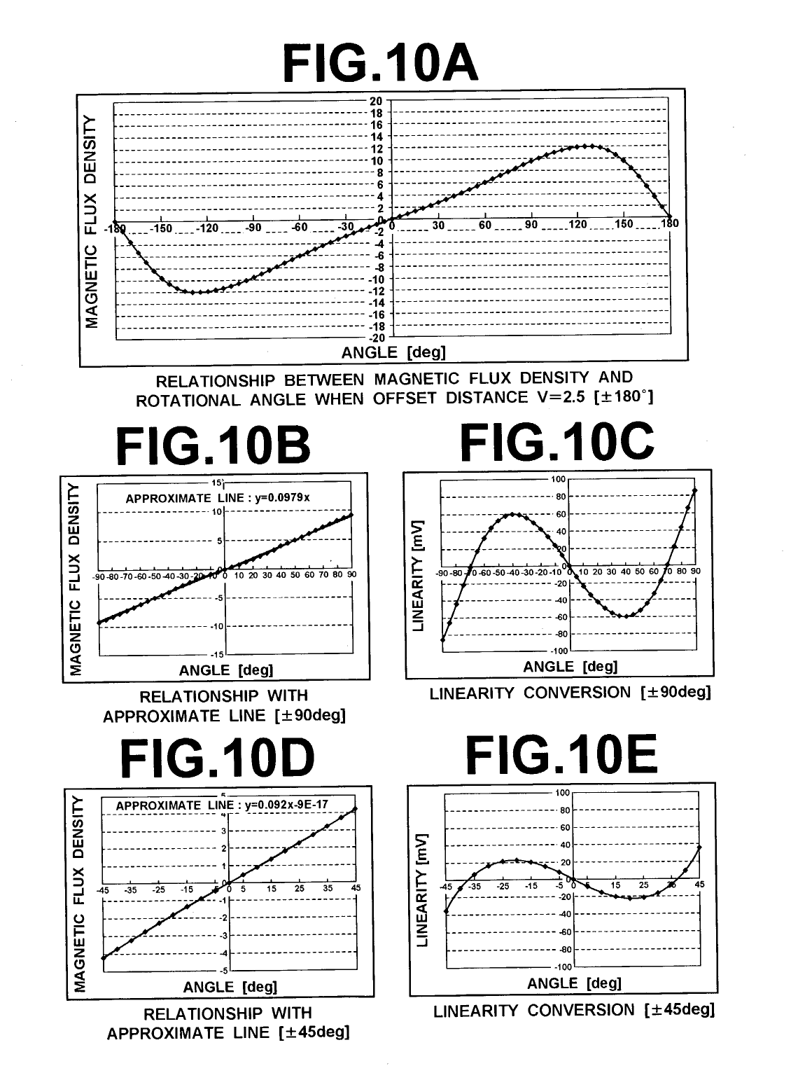

An embodiment of the present invention in which the offset distance V is 2.5 (and the ratio of the offset distance to the distance between the permanent magnet 36 and the rotational center C is 2.5:10) will now be described with reference to FIGS. 10A-10E. In the range of ±90°, the curve substantially overlaps the approximate line, and the degrees of deviation are within the range of approximately ±90 mV (see FIGS. 10B and 10C). This deviation translates to errors of approximately 1.8%. However, as in the embodiment wherein the offset distance V is 1.5 (FIGS. 8A-8E), this value indicates a significant improvement over the conventional angle sensor (FIGS. 5A-5E), and sufficiently effective detection is possible. Similarly, in the range of ±45°, the curve almost overlaps the approximate line, and the errors are within a range of approximately ±30 mV (see FIGS. 10D and 10E). This translates to errors of approximately 0.6% which are extremely small. Accordingly, in the embodiment wherein the offset distance V is 2.5, the sensor can be used as a highly accurate sensor in the range of ±90° as well as in the range of ±45°.

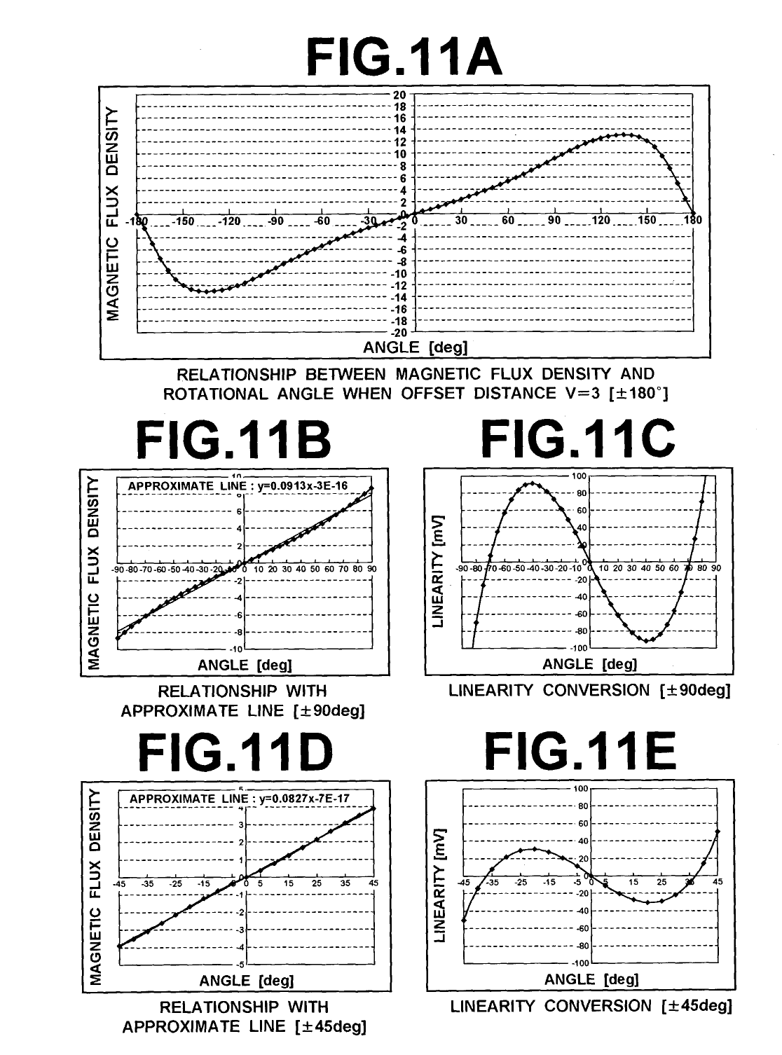

An embodiment of the present invention in which the offset distance V is 3 (and the ratio of the offset distance to the distance between the permanent magnet 36 and the rotational center C is 3:10) will now be described with reference to FIGS. 11A-11E. In the range of ±90°, the curve is somewhat shifted from the approximate line (see FIG. 1I B). At the ±90° positions, the degrees of deviation are very large (see FIG. 11C). Accordingly, the sensor cannot be used within this range. In the range of ±45°, the curve almost overlaps the line and errors are within the range of ±50 mV (see FIGS. 11D and 11E). This translates to errors of approximately 1%, and is sufficient for use of the sensor. Accordingly, in the embodiment wherein the offset distance V is 3, the sensor can be used as a highly accurate sensor in the range of ±45°.

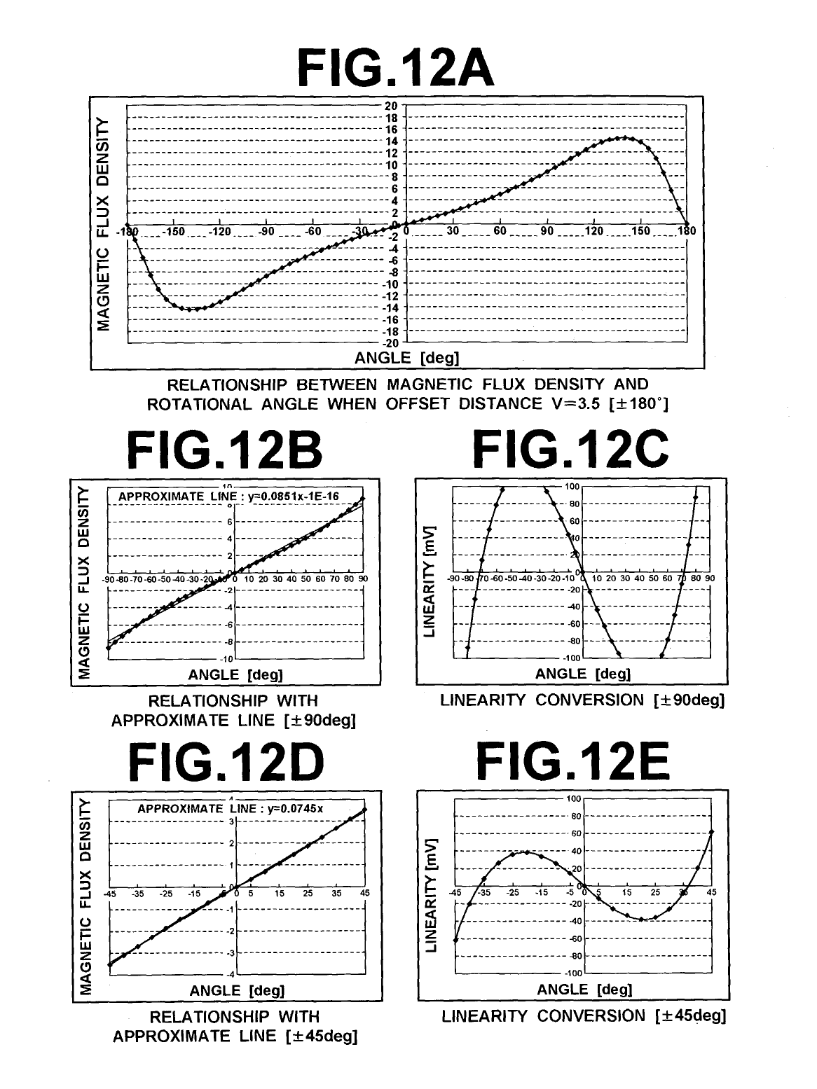

An embodiment of the present invention in which the offset distance V is 3.5 (and the ratio of the offset distance to the distance between the permanent magnet 36 and the rotational center C is 3.5:10) will now be described with reference to FIGS. 12A-12E. In the range of ±90°, the curve is slightly shifted from the approximate line (see FIG. 12B). At the ±90° positions as well as the ±40° positions, the degrees of deviation are very large (see FIG. 12C). Accordingly, the sensor cannot be used within this range. In the range of ±45°, the curve almost overlaps the line and errors are within the range of ±60 mV (see FIGS. 12D and 12E). This translates to errors of approximately 1.2% and is sufficient for use of the sensor. Accordingly, in the embodiment wherein the offset distance V is 3.5, the sensor can be used as a highly accurate sensor in the range of ±45°.

From the foregoing, it can be seen that in the range of ±90°, detection of the rotational angle at a higher accuracy than a conventional angle sensor, in which the Hall element is situated at the rotational center of a rotor, is possible when the offset distance V between the Hall element and the rotational center is within the range of 1.5 to 2.5. Among these offset distances, the best results are obtained when the offset distance V is 2 (FIG. 9C). In addition, it can be seen that in the range of ±45°, detection of the rotational angle at a higher accuracy than a conventional angle sensor, in which the Hall element is situated at the rotational center of a rotor, is possible when the offset distance V is within the range of 0.5 to 3.5. Among these offset distances, the best results are obtained when the offset distance V is 1.5 (FIG. 8E). Accordingly, sensors having offset distances V within the range of 0.5 to 3.5 may be used in accordance with the invention. The detected output electrical signal may be further improved with respect to the detection accuracy by correcting it with a correction circuit. In addition, for offset distances V in between the above-described offset distances V, it is assumed that intermediate data approximating the data obtained for the offset distances V on either side thereof are obtained. In this manner, by slightly shifting the position of the Hall element 50 from the rotational center C, a highly accurate sensor 1 is obtained. In view of the construction described above, the sensor may be manufactured with few parts and at low cost.

The foregoing illustrates some of the possibilities for practicing the invention. Many other embodiments are possible within the scope and spirit of the invention. For example, although it is necessary that the axis of the permanent magnet pass through the rotational center C, either the N pole or the S pole may be on the rotational center side. If the S pole is on the interior side as opposed to on the exterior side as in the above-described embodiments, the only change will be that the positive and negative output of the Hall element 50 will be reversed. This can be easily converted by a correction circuit and poses no practical problems. It is, therefore, intended that the foregoing description be regarded as illustrative rather than limiting, and that the scope of the invention is given by the appended claims together with their full range of equivalents.

What is claimed is:

1. An angle sensor comprising:
a rotor having a rotational center;
a permanent magnet arranged on said rotor for detecting a rotational angle of an object on which the sensor is mounted;
a housing portion; and
a Hall element arranged in connection with said housing portion for outputting an electrical signal corresponding to a magnetic flux density of said magnet, said rotor being rotatable relative to said housing portion such that said magnet arranged on said rotor is rotatable relative to said Hall element arranged in connection with said housing portion, said rotor having a reference position relative to said housing portion;
said magnet being arranged at a set distance from the rotational center of said rotor and such that the rotational center of said rotor is situated on an axis of said magnet;
said Hall element being arranged on said axis of said magnet on a side of the rotational center opposite a side on which said magnet is arranged and at an offset distance from the rotational center when said rotor is in the reference position, said Hall element being arranged such that a magnetic flux detection direction is perpendicular to said axis of said magnet, the offset distance between said Hall element and the rotational center of said rotor being smaller than the distance between said magnet and the rotational center of said rotor;
a ratio of the distance between said magnet and the rotational center of said rotor to the offset distance between said Hall element and the rotational center of said rotor and the rotational angle of said rotor being in a range in which the output electrical signal from said Hall element is a linear function of the rotational angle.

2. The angle sensor of claim 1, wherein the ratio of the distance between said magnet and the rotational center to the offset distance between said Hall element and the rotational center is within the range of 10:0.5 to 10:3.5.

3. The angle sensor of claim 2, wherein the rotational angle of said rotor is within the range of from +90° to −90°, and the ratio of the distance between said magnet and the rotational center to the offset distance between said Hall element and the rotational center is within the range of 10:1.5 to 10:2.5.

4. The angle sensor of claim 2, wherein the rotational angle of said rotor is within the range of from +45° to −45°.

5. The angle sensor of claim 1, wherein said magnet is arranged directly under the rotational center of said rotor when said rotor is in the reference position.

6. The angle sensor of claim 1, further comprising a housing defined by an insulative part having a space, said housing portion being a cover which mates with said insulative part and seals said space.

7. The angle sensor of claim 6, wherein said rotor is arranged in said space defined by said insulative part and sealed by said cover.

8. The angle sensor of claim 1, wherein said Hall element is arranged on said housing portion.

9. An angle sensor comprising:
a rotor having a rotational center and a reference position;
a permanent magnet arranged on said rotor for detecting a rotational angle of an object on which the sensor is mounted;
a housing portion;
a Hall element arranged in connection with said housing portion for outputting an electrical signal corresponding to a magnetic flux density of said magnet, said rotor being rotatable relative to said housing portion such that said magnet arranged on said rotor is rotatable relative to said Hall element arranged in connection with said housing portion;
said magnet being arranged at a set distance from the rotational center of said rotor and such that the rotational center of said rotor is situated on an axis of said magnet;
said Hall element being arranged on said axis of said magnet on a side of the rotational center opposite a side on which said magnet is arranged and at an offset distance from the rotational center when said rotor is in the reference position, said Hall element being arranged such that a magnetic flux detection direction is perpendicular to said axis of said magnet, the offset distance between said Hall element and the rotational center of said rotor being smaller than the distance between said magnet and the rotational center of said rotor;
a ratio of the distance between said magnet and the rotational center of said rotor to the offset distance between said Hall element and the rotational angle of said rotor being set such that the output electrical signal is within a predetermined margin of error.

10. The angle sensor of claim 9, wherein the ratio of the distance between said magnet and the rotational center to the offset distance between said Hall element and the rotational center is within the range of 10:0.5 to 10:3.5.

11. The angle sensor of claim 10, wherein the rotational angle of said rotor is within the range of +90° to −90°, and the ratio of the distance between said magnet and the rotational center to the offset distance between said Hall element and the rotational center is within the range of 10:1.5 to 10:2.5.

12. The angle sensor of claim 10, wherein the rotational angle of said rotor is within the range of +45° to −45°.

13. The angle sensor of claim 9, wherein said magnet is arranged directly under the rotational center of said rotor when said rotor is in the reference position.

14. The angle sensor of claim 9, further comprising a housing defined by an insulative part having a space, said housing portion being a cover which mates with said insulative part and seals said space.

15. The angle sensor of claim 14, wherein said rotor is arranged in said space defined by said insulative part and sealed by said cover.

16. The angle sensor of claim 9, wherein said Hall element is arranged on said housing portion.

17. An angle sensor comprising:
a housing having an interior space;
a rotor arranged in said interior space and having a rotational center;
a permanent magnet arranged on said rotor for detecting a rotational angle of an object on which the sensor is mounted;
a Hall element arranged in connection with said housing for outputting an electrical signal corresponding to a magnetic flux density of said magnet, said rotor being rotatable relative to said housing such that said magnet arranged on said rotor is rotatable relative to said Hall element arranged in connection with said housing, said rotor having a reference position relative to said housing;
said permanent magnet being arranged at a set distance from the rotational center of said rotor and such that the rotational center of said rotor is situated on an axis of said magnet;
said Hall element being arranged on said axis of said magnet on a side of the rotational center opposite a side on which said magnet is arranged and at an offset distance from the rotational center when said rotor is in the reference position, said Hall element being arranged such that a magnetic flux detection direction is perpendicular to said axis of said magnet, the offset distance between said Hall element and the rotational center of said rotor being smaller than the distance between said magnet and the rotational center of said rotor.

18. The angle sensor of claim 17, wherein a ratio of the distance between said magnet and the rotational center of said rotor to the offset distance between said Hall element and the rotational center of said rotor and the rotational angle of said rotor is in a range in which the output electrical signal from said Hall element is a linear function of the rotational angle.

19. The angle sensor of claim 17, wherein a ratio of the distance between said magnet and the rotational center of said rotor to the offset distance between said Hall element and the rotational angle of said rotor is such that the output electrical signal is within a predetermined margin of error.

20. The angle sensor of claim 17, wherein a ratio of the distance between said magnet and the rotational center to the offset distance between said Hall element and the rotational center is within the range of 10:0.5 to 10:3.5.

21. The angle sensor of claim 17, wherein the rotational angle of said rotor is within the range of +90° to −90°, and a ratio of the distance between said magnet and the rotational center to the offset distance between said Hall element and the rotational center is within the range of 10:1.5 to 10:2.5.

22. The angle sensor of claim 17, wherein the rotational angle of said rotor is within the range of +45° to −45°.

23. The angle sensor of claim 17, wherein said magnet is arranged directly under the rotational center of said rotor when said rotor is in the reference position.

24. The angle sensor of claim 17, wherein said rotor comprises a disc-shaped collar having a recess and a trunk portion perpendicular to said collar, said magnet being arranged in said recess.

25. The angle sensor of claim 24, wherein said housing defines a pair of stop surfaces and said collar includes a protrusion arranged to rotate along with said rotor between said stop surfaces such that said stop surfaces define a rotational range of said rotor.

26. The angle sensor of claim 17, further comprising contacts extending from said Hall element and having terminal ends, said Hall element being arranged on a Hall IC, said housing including a housing portion having an insertion opening receiving said Hall IC, a groove receiving said contacts and cavities receiving terminal ends of said contacts.

27. The angle sensor of claim 17, wherein said housing is defined by an insulative part having a space and a cover which mates with said insulative part and seals said space.

28. The angle sensor of claim 27, wherein said Hall element is arranged on said cover.
